(19) United States
(12) Patent Application Publication
(10) Pub. No.: US 2024/0133521 A1
(43) Pub. Date: Apr. 25, 2024

(54) Methane Retention System

(71) Applicant: Estis Compression, LLC, Kilgore, TX (US)

(72) Inventors: John Gatlin, Bellaire, TX (US); Chris LINDSEY, Carthage, TX (US); Greg NIEHUES, Garden City, TX (US); Will NELLE, San Angelo, TX (US)

(21) Appl. No.: 18/400,404

(22) Filed: Dec. 29, 2023

Related U.S. Application Data
(62) Division of application No. 18/195,685, filed on May 10, 2023.
Application No. 18/195,685 is a continuation-in-part of application No. 17/744,948, filed on May 16, 2022, now abandoned.
(60) Provisional application No. 63/189,556, filed on May 17, 2021.
(60) Provisional application No. 63/453,377, filed on Mar. 20, 2023.

(51) Int. Cl. F17C 5/00; F17D 1/07; F17D 5/00

(52) U.S. Cl. CPC F17C 5/002; F17D 1/07; F17D 5/005; F17C 2205/0326; F17C 2205/0338; F17C 2205/0352; F17C 2221/033; F17C 2227/0135; F17C 2227/0157; F17C 2260/035; F17C 2265/066

(57) ABSTRACT

A methane retention system is provided for reducing the amount of natural gas that is vented into the atmosphere during depressurization and maintenance of a natural gas compressor unit. Also provided are a method of depressurizing a natural gas compressor unit and a natural gas system, both of which include the methane retention system.

### CROSS REFERENCE

This application is a divisional of U.S. patent application Ser. No. 18/195,685 having a filing date of May 10, 2023, which is a continuation-in-part of U.S. patent application Ser. No. 17/744,948 having a filing date of May 16, 2022 and which claims the benefit of the filing date of U.S. Provisional Application No. 63/189,556 having a filing date of May 17, 2021. U.S. patent application Ser. No. 18/195,685 also claims the benefit of U.S. Provisional Patent Application No. 63/453,377, filed Mar. 20, 2023. The entire contents of each of which are incorporated by reference herein and the priority of each of which are hereby claimed.

### BACKGROUND

The present disclosure is directed to a methane retention system that minimizes or even eliminates the amount of natural gas that is vented to the atmosphere when a natural gas compressor is depressurized for maintenance or other reasons.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1A schematically illustrates an embodiment of a methane retention system of the disclosure that is installed for fluid communication with a natural gas compressor unit.

FIG. 1B schematically illustrates another embodiment of a methane retention system of the disclosure.

FIG. 2 is a perspective view of a potential commercial embodiment of a methane retention system installed for fluid communication with a natural gas compressor unit.

FIG. 3 is another perspective view of the apparatus of FIG. 2, taken from a different angle.

FIG. 4 schematically illustrates another embodiment of a methane retention system of the disclosure that is installed for fluid communication with a natural gas compressor unit.

FIG. 5 is a perspective view of a potential commercial embodiment of a methane retention system of FIG. 4 installed for fluid communication with a natural gas compressor unit.

FIG. 6 schematically illustrates a yet further embodiment of a methane retention system of the disclosure that is installed for fluid communication with a natural gas compressor unit.

### DETAILED DESCRIPTION

The systems, methods, and devices of the present disclosure each have several aspects, no single one of which is solely responsible for its desirable attributes. Without limiting the scope of this disclosure as expressed by the claims that follow, some features will now be discussed briefly. After considering this discussion, and particularly after reading this section, one will understand how the features of this disclosure provide advantages that include reduced or eliminating venting of greenhouse gases (GHG) from natural gas compressor stations.

In an embodiment of the present disclosure, a methane retention system for receiving, storing, and recycling vented natural gas from a natural gas compressor unit is provided. The methane retention system generally includes: at least one accumulator vessel; at least one recycle line in fluid communication with the accumulator vessel; at least one return line in fluid communication with the accumulator vessel; at least one valve in the recycle line; and at least one valve in the return line; wherein the methane retention system is configured to receive natural gas from the compressor unit, store the natural gas during maintenance of the compressor unit, and return the natural gas to the compressor unit following completion of the maintenance.

In an aspect of the present disclosure, a method of decompressing a compressor unit is provided. The method generally includes: isolating the compressor unit from a source of natural gas; placing an outlet of the compressor unit in fluid communication with at least one accumulator vessel; releasing natural gas from the compressor unit into the at least one accumulator vessel in fluid communication with the compressor unit until a first pressure inside the compressor unit is lowered to a desired second pressure; and isolating the accumulator vessel from the compressor unit to temporarily store the natural gas vented from the compressor unit.

In another embodiment of the present disclosure, a natural gas system is provided. The natural gas system generally includes: a compressor unit; and a methane retention system connected to the compressor unit; wherein the methane retention system is configured to accept and store natural gas from the compressor unit during depressurization of the compressor unit so that less than about 35% of the natural gas in the compressor unit or even less than about 10% of the natural gas in the compressor unit is released into an atmosphere during depressurization of the compressor unit.

When maintenance work is performed on a natural gas compressor that has been in service, the compressor unit must be depressurized to atmospheric pressure in order to enable access to the compressor unit and its components. Far more commonly, when a compressor unit shuts down (e.g., corresponding to well shut down etc.), the compressor unit typically requires at least partially depressurized (i.e., blow down) to allow restarting the compressor. That is, most compressor power sources (e.g., natural gas engines, electric motors etc.) cannot restart a static compressor unit while the compressor unit is fully pressurized as the back pressure exerted by pressurized cylinders of the compressor is too great for the power source to overcome. Depressurization to a lowered pressure or complete depressurization to atmospheric pressure has conventionally been accomplished by closing the inlet to the compressor unit, thereby isolating the unit from all upstream flow and pressure and opening a blowdown valve downstream of the final stage of the compressor unit until the compressor unit has been depressurized to atmospheric pressure. This depressurizing process has involved venting as much as 5000 standard cubic feet (scf) of natural gas into the atmosphere. Natural gas typically contains, in percent by volume, about 70% to nearly 100% methane, about 0-20% propane, and smaller amounts of ethane, butane, carbon dioxide, oxygen, nitrogen and hydrogen sulfide. Methane is the primary component. Natural gas is considered “dry” when it contains almost pure methane, having had most of the other components removed. Natural gas is referred to as “wet” when the other hydrocarbons are still present. Further, natural gas compressors are in widespread use in the oil and gas industry. Tens of thousands of compressors are in existence in the United States alone. Such compressors are used in conjunction with pipelines to move natural gas over short or long distances. Additionally, such compressors are used in high pressure gas lift (HPGL) operations where high-pressure gas is injected into production wells. Due to the availability of natural gas as an on-site fuel source, natural gas compressor packages are often powered by a natural gas fired internal combustion reciprocating engine, which commonly drives a reciprocating compressor.

Methane is considered a greenhouse gas that potentially harms the environment. According to the United Nations Economic Commission for Europe, methane in the air can, on a parts per volume basis, warm that air at a rate of 84 times that of carbon dioxide. It is therefore desirable to minimize the amount of natural gas vented into the atmosphere.

The present disclosure is directed to various embodiments of methane retention systems and methods for minimizing the amount of natural gas that is vented to the atmosphere during full or partial depressurization of a natural gas compressor. In an embodiment, the methane retention system includes at least one recycle line adapted for connection downstream of at least one stage of a natural gas compressor. In one embodiment, the recycle line is adapted for connection downstream of a final stage of the natural gas compressor unit. In another embodiment, two or more recycle lines are adapted for connection downstream of two or more stages of the natural gas compressor unit.

The methane retention systems may also include one or more accumulator vessels connected to the one or more recycle lines. The accumulator vessel(s) accumulates and holds the natural gas that would otherwise be vented into the atmosphere during the depressurization of the natural gas compressor unit. Each accumulator vessel can be an appropriately sized steel tank that is designed for holding gas under pressure and is capable of holding natural gas at pressures of up to about 10 atmospheres, or up to about 15 atmospheres, or up to about 20 atmospheres, or up to about 25 atmospheres. One suitable accumulator vessel is a steel tank manufactured by Quality Steel of Cleveland, MS, which is rated for pressures of up to 250 psig (17 atmospheres). Various sizes are available. In one embodiment, the vessel can have a capacity size (volume) of about 500 gallons (3740 scf). In other embodiments, the accumulator vessel can have a capacity (volume) of at least about 250 gallons (1870 scf), or at least about 500 gallons (3740 scf), or at least about 1000 gallons (7480 scf), or at least about 1500 gallons (11,220 scf) and/or up to about 2000 gallons (14,960 scf). In an embodiment, the methane retention system utilizes at least two accumulator vessels. In such an embodiment, a first accumulator vessel may be a high-pressure vessel and the second accumulator vessel may be a low-pressure accumulator vessel. In use, the compressor may, in a first step, vent to the high-pressure accumulator vessel for a first time period or first stage (e.g., until pressure equalization between the first accumulator vessel and the compressor unit). After such first step venting, an internal pressure of the compressor may be reduced. Subsequently, in a second step, the compressor may vent to the low-pressure accumulator vessel to further reduce an internal pressure of the compressor. The high- and low-pressure accumulator vessels may be isolated from one another during the first and second depressurizing steps. In further embodiments, a third accumulator vessel may be used to further reduce the internal pressure of the compressor.

The methane retention system also includes a return or recycle line leading from the accumulator vessel(s) back to an inlet of the compressor unit. In an embodiment, such a recycle line is adapted for connection to an inlet line to the natural gas compressor unit. The connection between the recycle line and the inlet line can be located upstream from the natural gas compressor unit. If the natural gas compressor unit has more than one stage, the connection between the recycle line and the inlet line can be located upstream from a first stage of the natural gas compressor unit. The accumulated natural gas is thereby commingled with natural gas from an external source and fed back into the natural gas compressor unit when operations resume. In another embodiment, the return/recycle line may be used to route gas stored in the accumulator vessels to a fuel inlet of a natural gas engine powering the compressor unit. In such an embodiment, the gas stored in the accumulator vessels is burned as fuel.

Using the above-described conventional technique in which the natural gas was vented into the atmosphere, the venting was allowed to continue until the pressure inside the natural gas compressor unit was reduced below a restart pressure that allowed restarting of the compressor unit or, more commonly, until pressure inside the natural gas compressor unit equilibrated with atmospheric pressure. By instead venting the natural gas into the accumulator vessel(s), the pressure inside the natural gas compressor unit will not equilibrate at atmospheric pressure, but will instead equilibrate at some elevated pressure whereby the pressure inside the accumulator vessel is raised due to the venting and the pressure inside the compressor unit is lowered until both pressures are equal nor near equal. In some instances, the reduced pressure inside the compressor unit is low enough to allow restarting the compressor unit without further venting. Such a restart pressure may be specific to compressors and their power sources (e.g., horsepower of power source, size of the compressor, etc.). In other instances (e.g., compressor maintenance), some (albeit a smaller quantity) of the natural gas in the compressor unit will thereafter have to be released into the atmosphere in order to bring the internal compressor pressure down to atmospheric pressure. This is typically accomplished by a) allowing the pressure in the compressor unit to equilibrate with the pressure in the accumulator vessel, then b) isolating the accumulator vessel using a shutoff valve to maintain the pressure in the accumulator vessel, then c) venting the remaining natural gas from the compressor into the atmosphere. Without further design and/or manipulation of the methane retention system, there will still be some natural gas in the compressor that is thereby vented into the atmosphere. In various embodiments, pumps and/or small compressors are utilized to capture natural gas remaining in the compressor.

The methane retention system can be designed with one or more additional features to further minimize the amount of natural gas that is vented into the atmosphere. One way is to size the accumulator vessel, and/or include two or more accumulator vessels in the methane retention system, so that the total volume of the accumulator vessel(s) is large relative to the volume in the natural gas compressor unit. For example, the total volume inside the one or more accumulator vessels can be at least about two times the volume inside the compressor unit, or at least about three times, or at least about four times, or at least about five times, or at least about six times, or at least about eight times, or at least about ten times the volume inside the compressor unit. As the volume of the accumulator vessel(s) is increased relative to the volume of the compressor unit, the equilibration pressure between the compressor unit and the accumulator vessel(s) becomes lower and closer to atmospheric pressure, and the amount of natural gas that ultimately needs to be released into the atmosphere from the compressor unit after the accumulator vessel(s) are then isolated is also lowered. Further, use of two or more accumulator vessels in a multi-step depressurization may result in a lowered internal pressure of the compressor unit, as discussed below.

Another way to minimize the amount of natural gas that is ultimately released into the atmosphere is to install a gas compressor or suction pump (e.g., gas pump) in the recycle line between the compressor unit and the accumulator vessel(s). In one embodiment, the gas compressor can include at least one suction compressor or suction pump. This will allow the gas pressure in the accumulator vessel(s) to be raised to a pressure above what would otherwise be an equilibration pressure, and the pressure in the compressor unit can be correspondingly lowered to atmospheric pressure. The accumulator vessel(s) can then be isolated after all or substantially all of the natural gas from the compressor unit has been transferred to the accumulator vessel(s) and little or no natural gas will then be left in the compressor unit for venting into the atmosphere.

The present disclosure is also directed to a method of depressurizing a natural gas compressor unit. The method can include the step of providing at least one accumulator vessel in fluid communication with a natural gas compressor. The accumulator vessel can include without limitation any of the accumulator vessels described above.

The method can include the step of releasing natural gas from the natural gas compressor unit into the at least one accumulator vessel until a first natural gas pressure in the natural gas compressor is at least reduced to or near an equilibrium level pressure in the at least one accumulator vessel. Using suitable techniques described above, the first natural gas pressure can be reduced to a pressure that is below the equilibrium level pressure.

The method then includes the steps of isolating the at least one accumulator vessel from the natural gas compressor unit and venting the natural gas compressor unit until the first pressure in the natural gas compressor unit reaches atmospheric pressure. This will enable maintenance to be performed on the natural gas compressor unit without risking an incident due to elevated pressure and/or the mere presence of excessive residual natural gas. Once the maintenance has been completed, the natural gas stored in the at least one accumulator vessel can be released back into the natural gas compressor unit.

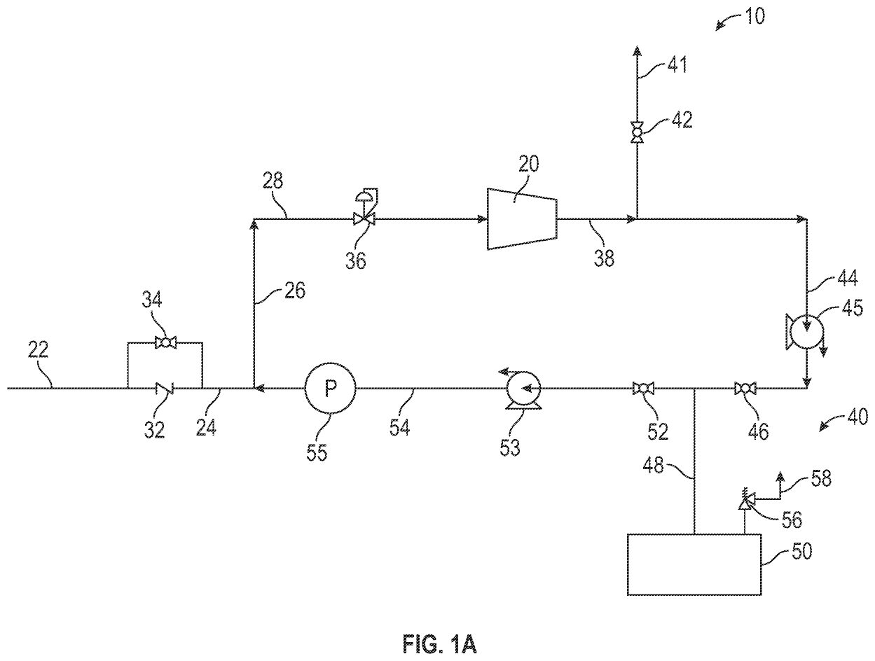

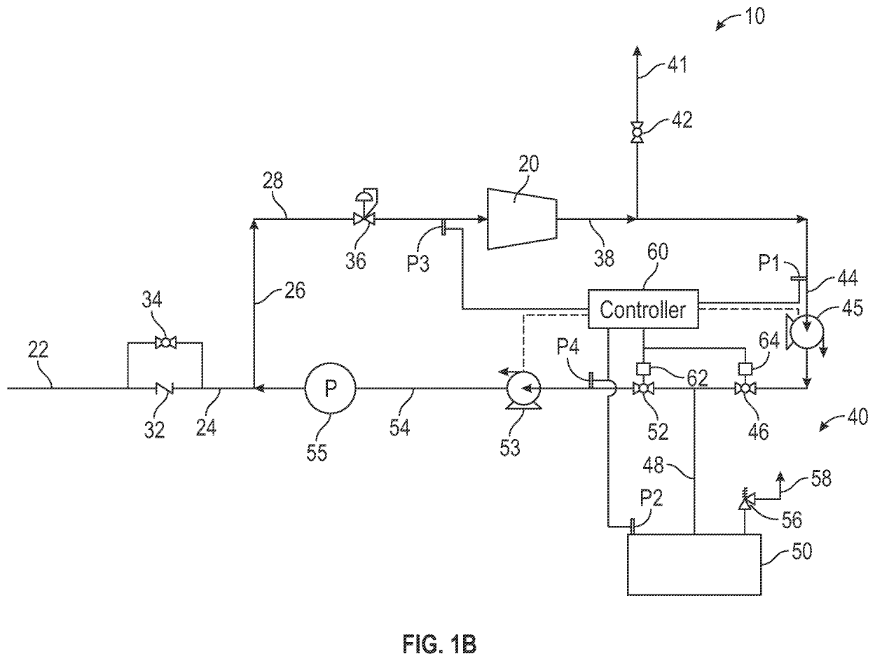

FIGS. 1A, 1B, 2 and 3 discuss one embodiment of a methane retention system and method. Referring to FIG. 1A, a natural gas compressor station 10 includes a compressor unit 20 connected for fluid communication with a methane retention system 40. During operation, the compressor unit 20 can receive natural gas from a source through a suction line 22 that can include a first suction line segment 24, which in turn feeds into a second suction line segment 26, which in turn feeds into a third suction line segment 28, which in turn feeds directly into the natural gas compressor unit 20. The first suction line segment 24 can be equipped with a check valve 32 connected in parallel with a ball valve 34 which can, in one embodiment, be a spring-type “dead man” ball valve. The second suction line segment 26 joins the first suction line segment 24 and the third suction line segment 28. The third suction line segment 28 is equipped with a suction control valve 36 that enables natural gas from the source to be pulled through the suction line segments 24, 26 and 28 with the aid of suction from the suction side of compressor unit 20 and fed into the natural gas compressor unit 20.

Natural gas compressor units are used in conjunction with pipelines to move natural gas over short or long distances. Natural gas compressor units work by mechanically increasing the gas pressure in stages or steps until the natural gas reaches a desired delivery point through a pipeline system. The pressure inside the compressor unit 20 will vary depending on the stage of compression, the size of the compressor unit 20 and the distance required for delivery. In one example of a three-stage reciprocating compressor, the natural gas might enter the inlet or “suction side” of the compressor unit at around 30 psi (two atmospheres) and ambient temperature. The first stage of compression might compress the natural gas to about 150 psi (ten atmospheres) and about 260° F. The second stage might increase the pressure to about 500 psi (34 atmospheres) and about 270° F. The third stage might further increase the pressure to about 1200 psi (82 atmospheres) and about 240° F. After each stage, the natural gas passes through a cooler and can be cooled to around 120° F. before entering the next stage. The natural gas compressor unit 20 illustrated in FIG. 1A can be representative of any natural gas compressor unit of any size, purpose and number of stages, because all such systems require depressurization and maintenance, and an objective of the present disclosure is to reduce the amount of natural gas that is vented into the atmosphere.

During operation, natural gas from the compressor unit 20 can exit into a natural gas pipeline (not shown) that carries the natural gas toward a desired destination. During a conventional (prior art) depressurizing operation for maintenance of the compressor unit 20, the suction control valve 36 is closed and natural gas can exit the compressor unit 20 through an exit line 38 that feeds directly into a blowdown line 41 equipped with a ball valve 42. When the ball valve 42 is open, the natural gas from the compressor unit 20 would thereby be vented directly into the atmosphere until the pressure inside the compressor unit 20 equilibrates with the surrounding atmosphere. In accordance with the present disclosure, the ball valve 42 remains closed and the natural gas from the compressor unit 20 instead passes from the exit line 38 into a recycle line 44 that carries the natural gas through an open recycle ball valve 46 and into the accumulator line 48, whereupon the natural gas vents into the at least one accumulator vessel 50. The venting continues as the natural gas pressure in the compressor unit 20 is lowered and the natural gas pressure in the accumulator vessel 50 is raised, until both pressures reach an equilibrium pressure. As explained above, the natural gas pressure in the compressor unit 20 can be minimized by selecting an accumulator vessel 50, or more than one accumulator vessel 50, having a total volume that is large relative to the volume of the compressor unit 20. The natural gas pressure in the compressor unit 20 can be lowered even further by employing an optional suction pump 45 or other suitable gas pump in the recycle line 44 or the accumulator line 48.

Once the natural gas pressure inside the compressor unit 20 has been minimized, the recycle ball valve 46 that regulates flow in the recycle line 44 can be closed to thereby isolate and temporarily store the vented natural gas in the accumulator vessel 50. During this entire venting operation, the return ball valve 52 located in the return line 54 connected to the accumulator line 48 can also remain closed in order to direct the flow of vented natural gas into the accumulator vessel 50. Once the accumulator vessel 50 has been isolated, any residual natural gas in the compressor unit 20 can then be vented and released into the atmosphere through the blowdown line 40 by opening the ball valve 42. Maintenance can then be performed on the compressor unit 20.

Once the maintenance on the compressor unit 20 has been completed, the compressor unit 20 can be restarted and the suction control valve 36 can be reopened to allow a new feed of natural gas from the source through the suction line 22. The return ball valve 52 located in the return line 54 can then be opened while the recycle ball valve 46 remains closed, allowing the natural gas in the at least one accumulator vessel 50 to flow through the return line 54 with the aid of suction control valve 36, whereupon the natural gas joins and mixes with new natural gas from the source in the second suction line segment 26 of suction line 22. A pressure regulator 55, which can be a pressure control valve, can also be included in the return line 54 to ensure that the natural gas from the accumulator vessel(s) 50 is fed at a controlled pressure so as not to overwhelm the compressor unit 20. Any residual natural gas that remains in the accumulator vessel(s) 50 can then be vented into the atmosphere by opening valve 56 in vent line 58. Alternatively, the natural gas from the accumulator vessel(s) can be more fully evacuated by employing an optional suction pump 53 or other suitable gas pump in the return line.

As will be apparent to persons of ordinary skill in the art, variations in the above description can be made to accommodate normal operational variations in natural gas compressor stations and the compressor units that are being used. If the compressor unit has three stages operating at different pressures, then all three stages can be vented into the recycle line 44 and the accumulator vessel(s) 50 either simultaneously or in steps. If, upon resuming operation, the pressure in the accumulator vessel is high relative to the desired natural gas pressure in the suction line 22, then a pressure regulator 55 may be placed in the return line 54 so that the natural gas in the accumulator vessel 50 can be gradually released, so as not to overwhelm the compressor unit 20. Depending on the size of the compressor unit and the layout of the plant, the methane retention system may include one very large accumulator vessel 50 whose volume is very large relative to the volume of the compressor unit 20, or may include a plurality of smaller vessels whose combined volume is very large relative to the volume in the compressor unit 20. Other variations from these embodiments will also be apparent to persons of ordinary skill in the art.

FIG. 1B illustrates another embodiment of a natural gas compressor station 10 including a compressor unit 20 connected for fluid communication with a methane retention system 40. The embodiment of FIG. 1B shares numerous components with the embodiment of FIG. 1A and the same reference numerals are utilized with common components of the embodiments. In the embodiment of FIG. 1B, a controller 60 monitors and controls the depressurization of the compressor unit 20, storage of natural gas in the methane retention system 40 and return of the natural gas to the compressor unit 20. As illustrated, the controller 60 is operatively connected to the recycle ball valve 46 and the return ball valve 52. More specifically, the controller 60 is operatively connected to actuators or solenoids 62, 64 attached to the valves 46, 52, respectively. The actuator/solenoids may be any appropriate mechanism (electric, pneumatic etc.) that allows the opening and closing of the valves in response to control outputs from the controller 60. For instance, a servo valve may be utilized to proportion flow through a given valve. The controller 60 may additionally be operatively connected to the suction control valve 36 on the inlet side of the compressor unit and/or the vent valve 42 on the outlet side of the compressor unit. The controller 60 is also connected to a plurality of pressure sensors or transducers ‘P’ that may be disposed within various system components. In an embodiment, a first pressure sensor P1 is disposed in the recycle line 44 and a second pressure sensor P2 is disposed in the accumulator vessel 50. In this embodiment, the first pressure sensor P1 may provide an output indicative of the pressure inside the compressor unit 20 (e.g., once the suction control valve is closed) and the second pressure sensor P2 may provide an output indicative of the pressure inside the accumulator vessel.

In operation, the controller may close the suction control valve 36, open the recycle valve 46 and close the return valve 52. The controller may monitor pressures in the recycle line (e.g., P1) and accumulator vessel (e.g., P2) to identify when the pressures equalize. At such time, the controller may close the recycle valve and open the vent valve 42. Alternatively, the controller 60 may, once pressure in the recycle line reaches a predetermined threshold, operate the pump 45 until pressure in the compressor unit/recycle line 44 reaches atmospheric pressure. At such time, the compressor may close the recycle valve 52 and discontinue operation of the pump 45. Though discussed as having first and second pressure sensors, it will be appreciated that additional pressure sensors may be incorporated. For instance, a pressure sensor P3 may be placed on the inlet side of the compressor unit and/or a pressure sensor P4 may be placed in the recycle line 54. In an embodiment, the pressure sensor P3 on the compressor unit inlet and pressure sensor P4 may be utilized to control the return of the natural gas to the compressor unit. In an embodiment, the depressurization may be an automated process. Likewise, once any necessary maintenance is performed on the compressor unit, the return of the natural gas may be an automated process.

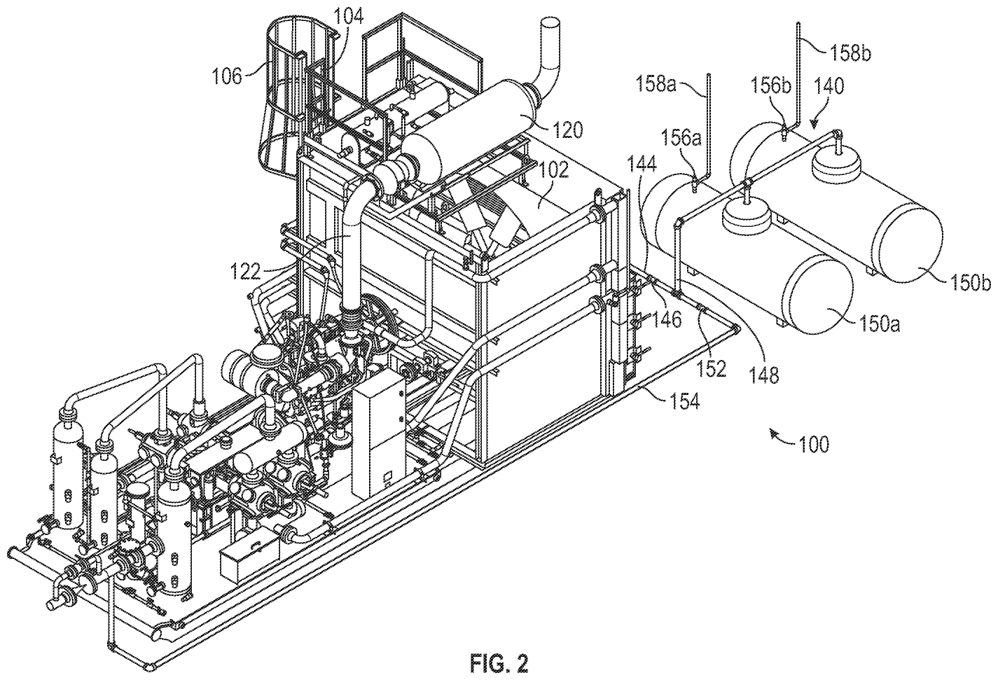

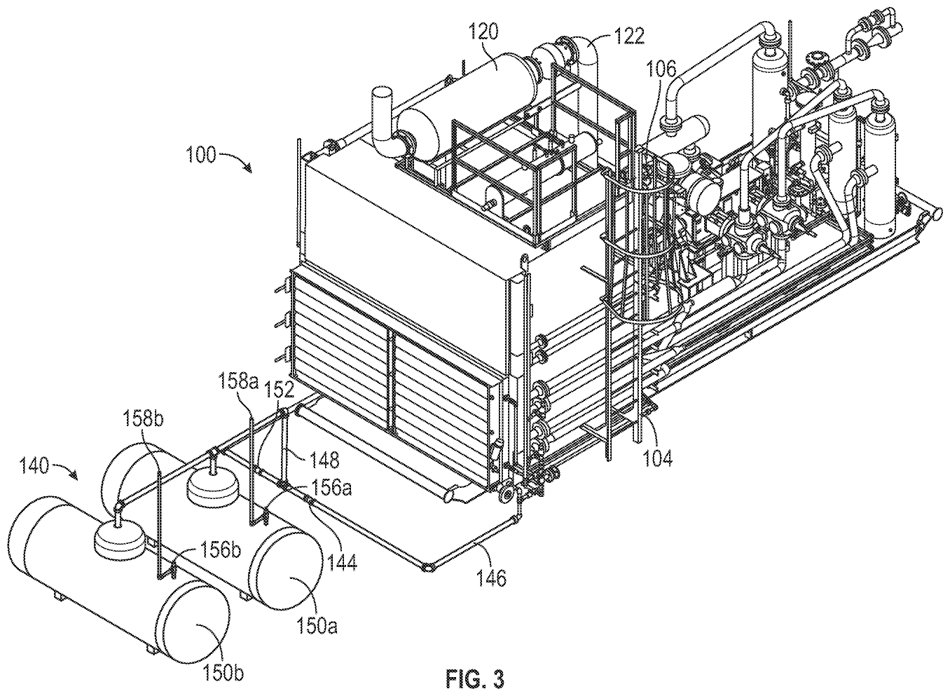

FIGS. 2 and 3 are opposing perspective views of an exemplary natural gas compressor station 100 that can be equipped with a methane retention system in accordance with the present disclosure. Because many of the illustrated features are conventional and known to persons of ordinary skill in the art, only the pertinent features will be further described. Natural gas compressor station 100 includes a natural gas compressor unit 120 positioned on an elevated platform 102. The platform 102 is equipped with ladder 104 and elevator 106 which permits access for maintenance. The station is equipped with a methane retention system 140 that includes two large accumulator vessels 150a and 150b, thereby providing a total accumulator vessel volume that is at least five times larger than the volume of the natural gas compressor unit 120. During normal operation, natural gas is fed to the compressor unit 120 via suction line 122 which, as shown, includes a plurality of suction line segments. When the compressor unit 120 requires maintenance, the suction line 122 is isolated from the compressor unit to enable the compressor unit to be depressurized and maintained. The residual natural gas in the compressor unit 120 is vented into the accumulator vessels 150a and 150b using the recycle line 144 which feeds the natural gas through the open recycle valve 146 and into the accumulator line 148. When the pressure inside the accumulator vessels 150a and 150b equilibrates with the residual pressure in the compressor unit 120, the recycle valve 146 is closed to isolate the vented natural gas in the accumulator vessels from the compressor unit 120. During this time, the return valve 152 in the return line 154 remains closed and any residual natural gas in the compressor unit 120 is vented into the atmosphere. When the maintenance has been completed and the compressor unit 120 is restarted, the return valve 152 is opened and the natural gas from the accumulator vessels 150a and 150b is released into the return line 154, whereupon the natural gas from the accumulators joins the natural gas being fed from the illustrated piping network to the suction line 122 and is recycled back into the compressor unit 120. Any residual natural gas in the accumulator vessels 150a and 150b can then be vented into the atmosphere by opening the valves 156 in the vent lines 158.

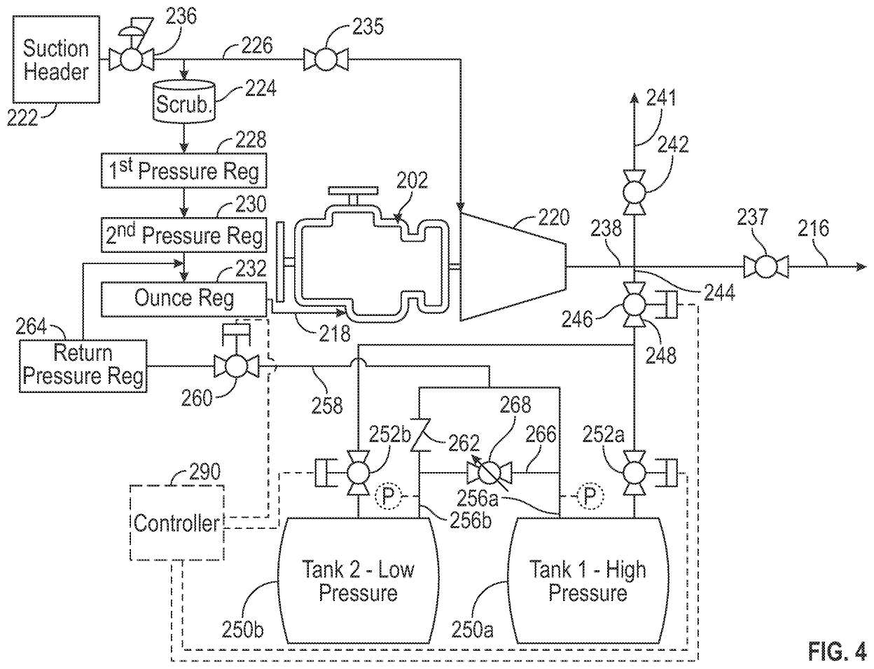

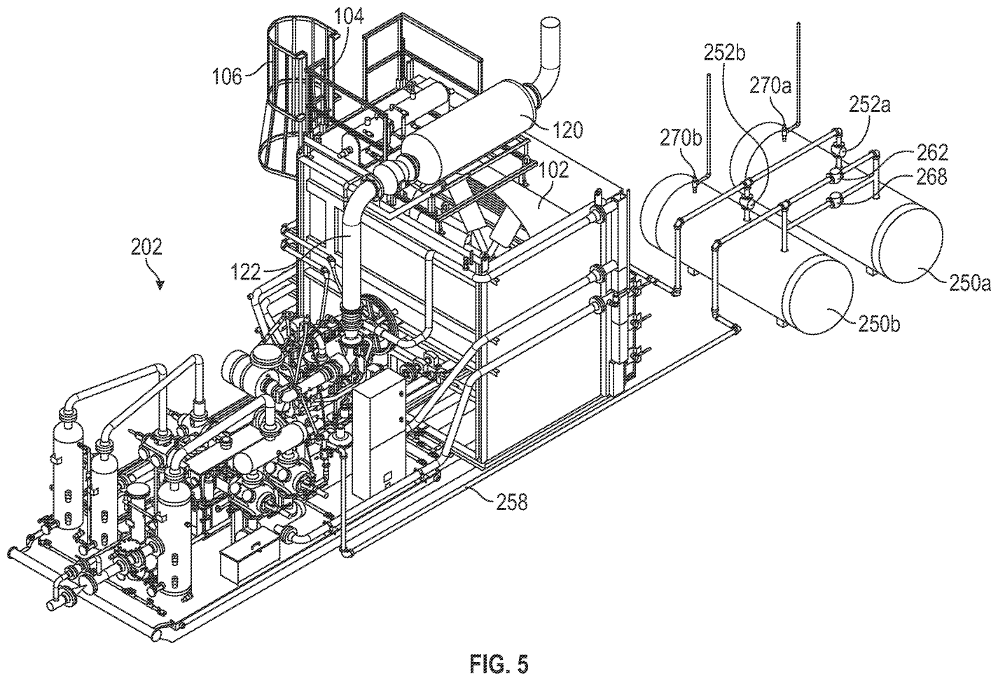

FIGS. 4 and 5 illustrate another embodiment of a methane retention system for use with a compressor unit. In this embodiment, the methane retention system is a multiple step decompression system (e.g., two-step, three-step) where the compressor is sequentially vented into separate accumulator vessels to further reduce the internal pressure of the compressor unit. Referring to FIG. 4, a natural gas compressor station includes a compressor unit 220 connected for fluid communication with a methane retention system 240. During operation, the compressor unit 220 can receive natural gas from a suction header 222. Gas from the suction header may pass through one or more suction line segments 226 that lead to an inlet of the natural gas compressor unit 220. The suction line segments can be equipped with various check valves, ball valves 235 and/or suction control valves 236 (e.g., pressure regulators) that enable natural gas from a source to be pulled through the suction line segment with the aid of suction from the suction side of compressor unit 220 and fed into the natural gas compressor unit 220.

In the illustrated embodiment, a natural gas fired internal combustion engine 202 is coupled to the compressor unit to rotate/reciprocate the compressor unit 220. In the illustrated embodiment, the engine 202 utilizes natural gas from the source (e.g., via the suction header) as a fuel source. In an embodiment, the raw natural gas received from the suction header passes through a natural gas scrubber 224 which removes traces of liquid form the natural gas being diverted for use as fuel for the engine 202. After passing through the scrubber 224, the scrubbed natural gas may pass through first and second pressure regulators 228, 230. The first pressure regulator 228 (e.g., a Fisher 630 Series “Big Joe” spring operated pressure regulator) may reduce the pressure from, for example, 100 psi to about 30 psi. The second pressure regulator 230 (e.g., a Fisher 627 Series “Little Joe” spring operated pressure regulator) may further reduce the pressure of the natural gas to be utilized as fuel to at or near a fuel inlet pressure (e.g., 20 psi) of the natural gas engine 202. After passing through the second pressure regulator 228, an ounce regulator 232 may meter the natural gas fuel to a fuel inlet 218 of the natural gas motor based on the power needs of the motor 202. Though shown as utilizing first and second pressure regulators 228, 230, it will be appreciated that other embodiments may utilize a single pressure regulator to reduce the inlet pressure of the natural to an inlet pressure of the natural gas motor 202.

During operation, natural gas from the compressor unit 220 can exit into a natural gas pipeline 216 or other downstream component that carries the natural gas toward a desired destination. If the compressor unit 220 shuts down for any reason (e.g., temporary shut-down due to well activity or for maintenance), the prior art depressurizing operation for restarting the compressor unit 220 requires closing an upstream control valve 235 and, in some instances, a downstream control valve 237 such that natural gas can exit the compressor unit 220 through an exit line 238 that feeds directly into a blowdown vent line 241 equipped with a ball valve 242. When the ball valve 242 is open, the natural gas from the compressor unit 220 would thereby be vented directly into the atmosphere until the pressure inside the compressor unit 220 equalizes with the surrounding atmosphere.

In accordance with the present embodiment where gas within a compressor unit is recovered rather than vented, the ball valve 242 in the blowdown vent line 241 remains closed and the natural gas from the compressor unit 220 instead passes from the exit line 238 into a blowdown recycle line 244 that carries the natural gas through an open recycle ball valve 246 and into an blowdown or accumulator line 248 that is selectively placed in fluid communication with a first accumulator vessel 250a and a second accumulator vessel 250b. More specifically, after isolating the compressor unit 220, the compressor unit 220 is first vented to the first accumulator vessel 250a. In such an arrangement, a first accumulator valve 252a is initially opened when the blowdown valve 246 is opened allowing the interior of the first accumulator vessel 250a to communicate with the accumulator line 248 and, hence, the interior of the compressor 220. Further, an outlet line 254a of the first accumulator vessel 250a is closed by a fuel release valve 260, as discussed below. A second accumulator vessel valve 252b is initially closed isolating the second accumulator vessel 252b from the accumulator line 248, the compressor 220 and the first accumulator vessel 250a. Once so configured, pressurized gas from inside the compressor 220 vents into the first accumulator vessel 250a, which may also be termed the high-pressure accumulator vessel 250a. After a period of time, the pressure inside the compressor 220 and the interior of the high-pressure accumulator vessel 250a may approach equalization or fully equalize. By way of example only, the accumulator vessels 250a, 250b may each have a 500-gallon interior volume with an initial interior pressure between atmospheric pressure and about 25 psig while the compressor unit 220 may have an initial internal pressure of around 1200 psi. In such an exemplary embodiment, the high-pressure accumulator vessel 250a and the interior of the compressor 220 may equalize at around 150 psig, due to the accumulator vessel 250a having a larger interior volume than the compressor 220.

Once the interior pressure of the compressor unit 220 is reduced to a desired pressure and/or equalized with the interior pressure of the high-pressure accumulator vessel 250a, the compressor unit 220 may be further vented to the second accumulator vessel 250b, which may be termed a low-pressure accumulator vessel 250b. To vent into the low-pressure accumulator vessel 250b, the first accumulator valve 252a is closed in conjunction with opening the second accumulator valve 252b. This allows the low-pressure interior of the low-pressure accumulator vessel 250b to communicate with the accumulator line 248 and the interior of the compressor 220. Additionally, an outlet line 254b of the second accumulator vessel 250b is closed by a fuel release valve 260, as discussed below. Further, the first accumulator vessel valve 252a is closed maintaining the interior of the high-pressure accumulator vessel 250a at its elevated pressure. Once so configured, the pressure from inside the compressor 220 further vents into the low-pressure accumulator vessel 250b. After a period of time, the pressure inside the compressor 220 and the interior of the low-pressure accumulator vessel may approach equalization or fully equalize. Continuing with the example from above, the low-pressure accumulator vessel 250b and the interior of the compressor 220 may equalize at around 40 psig. At this time, the second accumulator vessel valve 252b may be closed. Additionally, the recycle valve 246 of the accumulator line 248 may be closed.

Continuing with the example from above, the interior of the compressor unit 220 may be near 40 psig after sequentially venting to the first and second accumulator vessels 250a, 250b. At such a low interior pressure, the natural gas engine 202 may restart the compressor unit 220 without further pressure reduction. That is, in instances where the compressor has stopped running and only requires restarting rather than internal maintenance (e.g., requiring internal ambient pressure), all gas may be captured from the interior of the compressor unit 220 in the high-pressure and low-pressure accumulator vessels 250a, 250b and no gas need be vented. This is of considerable importance as restart procedures outnumber maintenance procedures (e.g., requiring ambient venting) approximately 8:1. Further, in maintenance situations, the remaining gas within the interior of the compressor unit may be vented via the vent line 241 or could be drawn out of the compressor unit 220 utilizing a suction pump or other suitable gas pump as discussed above in relation to the embodiment of FIGS. 1A and 1B. In the above-noted example, each accumulator vessel has a 500-gallon interior volume and the two-step depressurization results in a residual internal compressor pressure of approximately 40 psig after the second depressurization step. In contrast, use of a single accumulator vessel with double the capacity (e.g., 1000-gallon interior) may result in a significantly higher residual internal pressure (e.g., 100 psig) within the compressor that prevents restarting the compressor without venting.

While the use of the high-pressure and low-pressure accumulator vessels 250a, 250B allows capturing all gas for restart and capturing a majority of gas for maintenance purposes (e.g., atmospheric blowdown), the pressurized gas within these vessel 250a, 250b must be recaptured such that these vessels 250a, 250b are available for future blow-down events. As discussed above in relation to embodiment of FIGS. 1A and 1B, the gas stored in the high-pressure and low-pressure accumulator vessels 250a, 250b could be reintroduced into the inlet/suction line of the compressor unit 220. However, the present disclosure has, in an embodiment, identified a more efficient way of recovering the stored gas. Specifically, for compressor units with natural gas engines, gas from the high-pressure and low-pressure accumulator vessels 250a, 250b is fed to the fuel inlet 218 of the natural gas engine 202. Stated otherwise, the temporarily stored gas in the accumulator vessel 250a, 250b is burned as fuel.

To allow burning the gas stored in the high-pressure and low-pressure accumulator vessels 250a, 250b as fuel, each of these vessels includes an outlet line 256a, 256b that fluidly couple to natural gas recycle line such as fuel recovery line 258. Each outlet line 256a, 256b may also include a valve (not shown) for opening and closing the outlet lines. A fuel release valve 260 is disposed within the fuel recovery line 258. As noted above, this valve 260 is closed during venting to the high-pressure and low-pressure accumulator vessels 250a, 250b. Once the venting is completed and the first and second accumulator vessel valves 252a, 252b are closed, the fuel release valve 260 may be opened to provide fuel to the inlet of the natural gas engine 202. Of note, the gas pressure of the high-pressure accumulator vessel 250a and the and low-pressure accumulator vessel 250b are initially different. To prevent the two accumulator vessels from equalizing pressure via the fluidly connected outlet lines 256a, 256b, the low-pressure accumulator vessel outlet line 256b may include a one-way check valve 262. The check valve 262 prevents higher pressure gas from the high-pressure accumulator vessel 250a from migrating into the interior of the low-pressure accumulator vessel 250b.

To provide gas from the accumulator vessels 250a, 250b to the fuel inlet 218, the stored gas must be reduced to an acceptable inlet pressure. To accomplish this, a return/recycle line pressure regulator 264 is disposed in the fuel recovery line 258 between the fuel release valve 260 and a flow line between the fuel supply pressure regulator 230 and the ounce regulator 232. As discussed above, the last pressure regulator 230 of the fuel supply line prior to the ounce regulator 232 may provide natural gas at, for example, a pressure of about 20 psi. To preferentially utilize the gas stored in the accumulator vessels 250a, 250b, the return/recycle line pressure regulator 264 should provide gas to the ounce regulator at a slightly higher pressure, for example, about 22 psi. The higher pressure setting of the return/recycle line pressure regulator 264 allows the natural gas engine 202 to preferentially draw gas stored in the accumulator vessels 250a, 250b prior to drawing gas from the suction line. Accordingly, internal pressures of the accumulator vessels 250a, 250b will eventually be drawn down to the set pressure of the return/recycle line pressure regulator 264. Of further note, the check valve 262 in the low-pressure accumulator vessel outlet line 256b remains closed until the system draws enough gas from the high-pressure accumulator vessel 250a to equalize the pressure in the two accumulator vessels 250a, 250b. Once the pressures are equalized, gas from the low-pressure accumulator vessel 250b may be drawn through the check valve 262, which is no longer maintained in a closed position by higher pressure gas from the high-pressure accumulator vessel 250a.

In the embodiment illustrated in FIG. 4, the outlet line 256a, 256b of the two accumulator vessels 250a, 250b, are additionally fluidly coupled by a by-pass line 266. The by-pass line includes a back pressure valve 268. The back pressure valve may have a setting that allows gas from the high-pressure accumulator vessel 250a to migrate to the low-pressure accumulator vessel 250b in over-pressure situations. For instance, the back pressure valve 260 may have a setting that is 10-20% lower than a pressure rating of the high-pressure accumulator vessel 250a. In an exemplary embodiment, the high-pressure accumulator vessel 250a may have a pressure rating of 250 psi and the back pressure valve 268 may have a 220-psi opening pressure. In any arrangement, the by-pass line 266 and the back pressure valve 268 may prevent over pressurization of the high-pressure accumulator vessel 250a. This safety feature may be of importance in instances wherein an additional blow-down event occurs prior to emptying the accumulator vessels 250a, 250b after a prior blow-down event. In addition, each of the accumulator vessels 250a, 250b may include a safety valve 270a, 270b that may vent to atmosphere in the event of over pressurization. See. FIG. 5.

It has been found that the multiple-step venting into the high-pressure accumulator vessel 250a and the and low-pressure accumulator vessel 250b may allow for capturing two or three full blow-down events while allowing the natural gas engine 202 to restart the compressor unit 220. That is, while each subsequent blow-down event (e.g., prior to fully recycling the gas temporarily stored in the accumulator vessels) further increase the pressure inside each accumulator vessel 250a, 250b, resulting in a larger residual pressure within the compressor unit, the residual pressure in the compressor unit may still be overcome by the natural gas engine allowing compressor unit restart without atmospheric venting.

Operation of the methane retention system 240 described in relation to FIG. 4, may be performed manually utilizing manual valves. However, in a further embodiment, the multiple step blowdown process may be automated using remotely actuated valves. In the latter embodiment, the system 240 may optionally include a controller 290 which is operative to communicate with and control at least the automatic blowdown valve 246, the accumulator vessel valves 252a, 252b and the fuel release valve 260. In an embodiment, the controller 290 receives a signal (e.g., Run Status Signal) from the engine 202 confirming the engine is operating (e.g., a positive voltage signal). Once it is identified the engine is no longer running and a blowdown event is necessary, the controller 290 may begin the blowdown process. That is, the controller may open the blowdown valve 246 and close the fuel release valve 260. Of note, the fuel release valve may be closed any time there is a negative Run Status Signal as there is no place of the gas to go when the engine is not running. The controller, while waiting for a blowdown event, may maintain the high-pressure accumulator vessel valve 252a in an open position and the low-pressure accumulator valve 252b in a closed position. Once the blowdown event is identified and the blowdown valve 246 is opened, the first blowdown step begins with the compressor unit 220 venting into the high-pressure accumulator vessel 250a. In various embodiments, this step may be controlled based on time (e.g., a timer in the controller 290) based on pressure of one or more pressure sensors and/or a differential pressure between the compressor 220 or accumulator line 248 and the interior of the high-pressure accumulator vessel. This reduces the pressure within the compressor unit 220 from a first pressure to a lower second pressure. Based on time or pressure, the controller 290 may then close the high-pressure accumulator vessel valve 252a and an open the low-pressure accumulator valve 252b to begin the second step of the blowdown. As above, the second step may be controlled based on time and/or based on pressure. This reduces the pressure within the compressor unit 220 from the second pressure to a lower third pressure. At the end of the second step, the controller 290 may close the accumulator vessel valves 252a, 252b and/or the blowdown valve 246. Further, the controller 290 may open the fuel release valve 260 to being utilizing the gas stored in the accumulator vessels 250a, 250b as fuel for the natural gas engine 202. Further, the compressor unit may be restarted, for example, while having the third internal pressure.

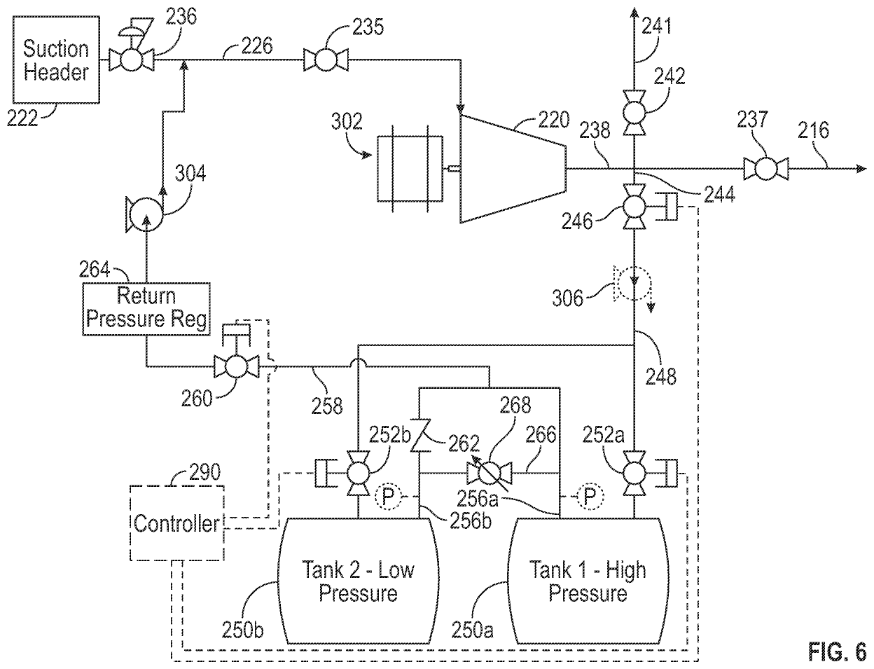

FIG. 6 illustrates another embodiment of a methane retention system for use with a compressor unit. In this embodiment, the methane retention system is another multiple-step decompression system where the compressor is sequentially vented into separate accumulator vessels to further reduce the internal pressure of the compressor unit. The system of FIG. 6 shares numerous components with the system of FIG. 4 and like reference numbers are used to refer to like elements. One primary difference is that the system of FIG. 6 utilizes an electric motor 302 to operate the compressor. As illustrated, the natural gas compressor station includes a compressor unit 220 that receives natural gas from a suction header 222. Gas from the suction header may pass through one or more suction line segments 226 that lead to an inlet of the natural gas compressor unit 220. The suction line segments can be equipped with various check valves, ball valves 235 and/or suction control valves 236 (e.g., pressure regulators) that enable natural gas from a source to be pulled through the suction line segment with the aid of suction from the suction side of compressor unit 220 and fed into the natural gas compressor unit 220. In the illustrated embodiment, the electric motor 302 is coupled to the compressor unit to rotate/reciprocate the compressor unit 220.

During operation, natural gas from the compressor unit 220 can exit into a natural gas pipeline 216 or other downstream component that carries the natural gas toward a desired destination. If the compressor unit 220 shuts down for any event (e.g., temporary shut-down due to well activity or for maintenance) gas within a compressor unit is recovered rather than vented through a blowdown vent line 241. In such an event, the natural gas from the compressor unit 220 passes from the exit line 238 into a blowdown recycle line 244 that carries the natural gas through an open recycle ball valve 246 and into an blowdown or accumulator line 248 that is selectively placed in fluid communication with a first accumulator vessel 250a and a second accumulator vessel 250b.

Operation of the methane retention system of FIG. 6 in relation to venting to the first and second accumulator vessels 250a, 250b (e.g., blowdown capture) is substantially similar to the operation set forth in in relation to FIG. 4 and may again be automated using a controller 290 and various automated/actuated valves. Again, a multiple step process may be followed where natural gas within the compressor unit 220 is vented to the first accumulator vessel 250a for a predetermined time or until a predetermined pressure drop occurs and then to the second accumulator vessel 250b for a predetermined time or until a predetermined pressure drop occurs.

Again, the use of the high-pressure and low-pressure accumulator vessels 250a, 250B allows capturing all gas for restart and capturing a majority of gas for maintenance purposes (e.g., atmospheric blowdown). Likewise, the pressurized gas temporarily within these vessel 250a, 250b must be recaptured such that these vessels 250a, 250b are available for future blow-down events. Unlike the embodiment of FIG. 4, which utilizes a natural gas engine to run the compressor unit and utilizes the temporarily stored gas as fuel, the electric motor 302 of the present embodiment cannot utilize the temporarily stored gas as fuel. Rather, the temporarily stored gas must be reintroduced to the inlet side/suction inlet of the compressor unit 220.

To route the temporarily stored gas within the accumulator vessels 250a, 250b to the compressor suction inlet (e.g., suction header 222 and/or suction line segments 226), each of these vessels includes an outlet line 256a, 256b fluidly coupled to a natural gas recycle line 258. Each outlet line 256a, 256b may also include a valve (not shown) for opening and closing the outlet lines. A fuel release valve 260 is disposed within the recycle line 258. This valve 260 may be closed during venting to the high-pressure and low-pressure accumulator vessels 250a, 250b. Once the venting is completed and the first and second accumulator vessel valves 252a, 252b are closed, the fuel release valve 260 may be opened to provide the temporarily stored gas to the suction inlet of the compressor unit 220. As noted above, the gas pressure of the high-pressure accumulator vessel 250a and the and low-pressure accumulator vessel 250b are initially different. To prevent the two accumulator vessels from equalizing pressure via the fluidly connected outlet lines 256a, 256b, the low-pressure accumulator vessel outlet line 256b may include a one-way check valve 262. The check valve 262 prevents higher pressure gas from the high-pressure accumulator vessel 250a from migrating into the interior of the low-pressure accumulator vessel 250b.

To provide gas from the accumulator vessels 250a, 250b to the suction header 222 and/or suction line segment(s) 226 (hereafter “suction inlet of the compressor”), the temporarily stored gas could be vented directly into, for example, suction inlet of the compressor. However, this would only reduce the pressure of the accumulator vessels 250a, 250b to the pressure of the gas in the suction header, which may be 60-70 psi or greater. In such a situation, temporarily stored gas in the high-pressure accumulator vessel 250a may partially flow into the suction header. Temporarily stored gas in the low-pressure accumulator vessel 250b may not flow at all. Such an arrangement may result in the accumulator vessels 250a, 250b having a starting internal pressure that is too high for effective blowdown capture and/or compressor restart. To avoid this situation, the present embodiment utilizes a small compressor 304 (e.g., return compressor) that is disposed within the recycle line 258 between the accumulator vessel 250a, 250b and the suction inlet. The return compressor 304 may be a small electrically driven unit. For example, the return compressor 304 may be a small reciprocating piston compressor, a scroll compressor or a vane-type compressor among others.

During operation, as soon as the primary compressor unit 220 is back online (e.g., a positive Run Status is received by the controller 290), the blowdown valve 246 will close (stopping any gas from the compressor unit going to the accumulator vessels) and the gas return valve 260 will open supplying gas from the two accumulator vessels 250a, 250b via the recycle line 258 into a pressure regulator 260. The pressure regulator 260 may drop the pressure of the gas in a subsequent portion of the recycle line down into the 5-10 psi range. This low-pressure gas will then flow into the suction side of the return compressor 304, which will compress the gas to a pressure of around 70-80 psi. This compressed gas will then flow into the suction inlet of the compressor 220. That is, the return compressor 304 elevates the pressure of the gas to a level sufficient to allow its reinjection into the suction header. A check valve may be disposed between the return compressor 304 and the suction inlet to prevent backward flow. This process will continue until the two (or more) accumulator vessels 250a, 250b are pulled down to roughly zero psig (atmospheric pressure), at which point the return compressor 304 will be shut down by means of a pressure switch. At this point the methane retention system is fully reset and ready to take another blowdown event. Of note, use of the return compressor to pull the accumulator vessels 250a, 250b down to nearly zero psig allows capturing more gas from the compressor unit and/or achieving a lower pressure in the low-pressure accumulator vessel and a correspondingly lower internal pressure in the compressor unit for restart. It will be appreciated that such a return compressor may also be incorporated into the methane retention system of FIG. 4 to further reduce the internal pressure of the accumulator vessels.

As illustrated in FIG. 6, the methane retention system may optionally incorporate a draw-down compressor 306 in the accumulator line 248. Such a draw-down compressor 306 may also be incorporated with the system of FIG. 4. During the blowdown capture phase, for either a gas-driven or electrically driven compressor, the presented methane retention systems are limited on how much gas can temporarily be stored from the compressor unit 220 by the final pressure in the low-pressure accumulator vessel 250b. For example, if the compressor unit 220 and low-pressure accumulator vessel equalize at 58 psi in the second blowdown step, then the compressor unit will still have a 58-psi internal pressure. As outlined above, such an elevated internal pressure of the compressor unit may be fine for an immediate or short-term restart scenario, which covers about 80% of the shutdown cases. However, for the remaining cases involving opening up the pressurized sections of the compressor unit (e.g., atmospheric blowdown), the remaining gas within the compressor unit may be atmospherically vented. However, by utilizing a small compressor in the accumulator line (e.g., accumulator compressor 306), during a blowdown event, the multiple step venting process will proceed as previously described the gas has settled out at a stable pressure and is no longer flowing on its own into the low-pressure accumulator vessel 250b. This would normally be the end of the blowdown capture phase. However, with incorporation of the accumulator compressor 306, gas from the blowdown recycle line 244 (e.g., outlet of the compressor unit 220) may be provided to the suction side of the accumulator compressor 306, which may compress the gas into the low-pressure accumulator vessel 250b. In an embodiment, the accumulator compressor 306 can continue to evacuate gas from the compressor unit 220 all the way down to atmospheric pressure and then shutdown. The blowdown event is now complete and the compressor unit 220 has effectively no pressurized gas onboard. At this time, the accumulator compressor 306 shuts down and the first and second accumulator vessel valves 252a and 252b are closed thereby temporarily storing the gas vented/evacuated from the compressor unit. At this time the compressor unit 220 is available for al maintenance events, including opening the gas sections, without any release to atmosphere.

Though discusses as utilizing separate compressors 304 and 306 in the return lines and accumulator lines, respectively, it will be appreciated that in other embodiments, the methane retention system(s) may utilize a single compressor for accumulation and return of the gas. In such an embodiment, a pair of actuated valves on the inlet and outlet of such a single compressor may enable changing from where the gas is drawn and to where the gas is pumped.

In further embodiments, it will be appreciated that discloses methane retention systems may be skid mounted. That is, may existing natural gas compressor units are remote systems, which may themselves be skid mounted. A skid mounted methane retention system (e.g., accumulator vessels, accumulator and/or return compressors, controllers, valves etc.) may be disposed near an existing compressor unit and plumbed into the compressor system.

The present disclosure thus provides methane retention systems, methods of depressurizing a natural gas compressor unit, and overall natural gas compressor systems that includes one of the methane retention systems, where the foregoing method can be practiced. The amount of natural gas that is released into the atmosphere can thereby be reduced by a least about 65 percent, or at least about 75 percent, or at least about 85 percent, or at least about 90 percent, or at least about 95 percent or even 100 percent compared to a natural gas compressor station that does not include one of the methane retention systems. Stated from another perspective, when the natural gas compressor unit is decompressed according to the method described herein, less than about 35 percent, or less than about 25 percent, or less than about 15 percent, or less than about 10 percent, or less than about 5 percent or even 0 percent of the residual natural gas in the compressor unit will be released into the atmosphere.

1. A method of decompressing a compressor unit, comprising the steps of:
isolating the compressor unit from a source of natural gas;
placing an outlet of the compressor unit in fluid communication with a first accumulator vessel;
releasing natural gas from the compressor unit into the first accumulator vessel in fluid communication with the compressor unit until a first pressure inside the compressor unit is lowered to a second pressure;
isolating the first accumulator vessel from the compressor unit to temporarily store a first portion of the natural gas vented from the compressor unit;
placing an outlet of the compressor unit in fluid communication with a second accumulator vessel;
releasing natural gas from the compressor unit into the second accumulator vessel in fluid communication with the compressor unit until a second pressure inside the compressor unit is lowered to a third pressure
isolating the second accumulator vessel from the compressor unit to temporarily store a second portion of the natural gas vented from the compressor unit.

2. The method of claim 1, further comprising: providing natural gas from at least one of the first and second accumulator vessels to a fuel inlet of a natural gas engine attached to the compressor unit.

3. The method of claim 2, further comprising reducing pressure of the natural gas prior to providing the natural gas to the fuel inlet.

4. The method of claim 2, further comprising providing the natural to the fuel inlet at a pressure higher than a fuel pressure of a primary fuel source of the natural gas engine.

5. The method of claim 1, further comprising pumping natural gas from at least one of the first and second accumulator vessels to a suction header of the compressor unit.

6. The method of claim 1, wherein the releasing and isolating steps are performed by opening and closing valves.

7. The method of claim 6, wherein a controller opens and closes the valves based on time or pressure.

8. The method of claim 1, further comprising: shutting down operation of the compressor unit prior to the isolating and releasing steps.

9. The method of claim 1, further comprising: restarting operation of the compressor unit while the internal pressure of natural gas within the compressor unit is at the third pressure.

10. The method of claim 1, wherein the third pressure is less than a maximum restart pressure for an engine attached to the compressor.
